(19) United States
(12) Patent Application Publication
(10) Pub. No.: US 2010/0116253 A1
(43) Pub. Date: May 13, 2010

(54) CONTROLLER FOR FUEL PUMP

(76) Inventors: Daiji Furuhashi, Chiryu-city (JP); Kiyoshi Nagata, Nagoya-city (JP); Katsuhiko Nakabayashi, Handa-city (JP)

Correspondence Address: NIXON & VANDERHYE, PC, 901 NORTH GLEBE ROAD, 11TH FLOOR, ARLINGTON, VA, 22203, US

(21) Appl. No.: 12/605,714

(22) Filed: Oct. 26, 2009

(30) Foreign Application Priority Data
Nov. 7, 2008 (JP) 2008-287104

(51) Int. Cl. F02M 37/04; F04B 49/00

(52) U.S. Cl. 123/495; 417/300

(57) ABSTRACT

An integrated value of discharge quantity of a fuel pump is used as a parameter evaluating a pressure loss of a fuel filter. A target discharge quantity is obtained by correcting a fuel quantity required by an engine with a filter pressure loss correction amount corresponding to an integrated value of the discharged quantity. A target rotational speed of the fuel pump is computed based on the target discharge quantity, so that the target rotational speed is corrected in accordance with the pressure loss of the fuel filter. Alternatively, the target rotational speed may be corrected in accordance with a deterioration degree of the fuel pump.

### CROSS-REFERENCE TO RELATED APPLICATION

This application is based on Japanese Patent Application No. 2008-287104 filed on Nov. 7, 2008, the disclosure of which is incorporated herein by reference.

### FIELD OF THE INVENTION

The present invention relates to a controller for a fuel pump which pumps up a fuel in a fuel tank and supplies the fuel to an internal combustion engine.

### BACKGROUND OF THE INVENTION

A conventional fuel supply apparatus is provided with a pressure regulator at an outlet of a fuel pump which pumps up a fuel in a fuel tank. The fuel pump is driven at a constant speed and discharges the fuel in a constant quantity. The pressure regulator adjusts a pressure of fuel discharged from the fuel pump at a constant pressure. The adjusted fuel is supplied to a fuel injector.

In this case, since the fuel pressure is configured to be able to discharge the fuel corresponding to a maximum fuel consumption of the engine, the discharge quantity of the fuel pump is usually larger than a fuel consumption of the engine. An excessive fuel is returned to the fuel tank by the pressure regulator, and the fuel corresponding to the fuel consumption is supplied to the fuel injector. Thus, usually, the fuel pump continues to discharge the fuel more than necessary, which wastes an excessive electricity of the fuel pump and deteriorates fuel economy.

JP-2008-19755A describes that a target discharge quantity of a fuel pump is computed in accordance with a driving condition of the engine, a target rotational speed is derived from the target discharge quantity, and an actual rotational speed of the fuel pump is adjusted to the target rotational speed.

However, it is unavoidable that a characteristic of discharge quantity relative to the rotational speed of the fuel pump largely varies with age. For example, since the fuel discharged from the fuel pump is filtered by a fuel filter, a pressure loss of the fuel filter is a factor which decreases the discharge quantity of the fuel pump. As a using period of the fuel filter becomes longer, the fuel filter is gradually clogged and the pressure loss of the fuel filter becomes gradually large. Thus, it is unavoidable that the discharge quantity (fuel quantity supplied to the fuel injector through the fuel filter) is gradually decreased with an increase in pressure loss even if the rotational speed of the fuel pump is unchanged.

Besides, as a using period of the fuel pump becomes longer, a sliding portion of each part is gradually worn away and a fuel leakage in the fuel pump is gradually increased, so that a pump efficiency is deteriorated. Thus, it is unavoidable that the discharge quantity is gradually decreased with a deterioration in pump efficiency even if the rotational speed of the fuel pump is unchanged.

Conventionally, in view of the decrease in discharge quantity, in order that the fuel corresponding to the maximum fuel consumption of the engine can be supplied even when the lifetime of the fuel pump and the fuel filter has passed, the target discharge quantity and the target rotational speed are established to be high, supposing a maximum pressure loss of the fuel filter and a maximum deterioration in fuel pump at the end of lifetime thereof. Even though the pressure loss of the fuel filter and the deterioration degree of the fuel pump are normally less than that at the end of lifetime thereof, the fuel pump excessively discharges the fuel by the target discharge quantity and at the target rotational speed for the end of lifetime thereof. A large part of the fuel is not supplied to the fuel injector and is returned to the fuel tank by the pressure regulator. That is, the fuel pump wastes the excessive electricity to deteriorate the fuel economy.

### SUMMARY OF THE INVENTION

The present invention is made in view of the above matters, and it is an object of the present invention to provide a controller for a fuel pump which can restrict a usual discharge quantity and can improve a fuel economy.

According to the present invention, a controller for a fuel pump, which pumps up a fuel in a fuel tank by the fuel pump, filtrates the fuel by a fuel filter and supplies the fuel to an internal combustion engine. The controller includes a filter evaluating means for evaluating a pressure loss of the fuel filter and a control means for controlling a discharge quantity of the fuel pump by controlling a rotational speed of the fuel pump. The control means corrects the rotational speed of the fuel pump in accordance with the pressure loss of the fuel filter evaluated by the filter evaluating means so as to correct the discharge quantity of the fuel pump in accordance with the pressure loss. Thereby, the target discharge quantity and the target rotational speed of the fuel pump are defined in accordance with the actual pressure loss of the fuel filter. Thus, the normal discharge amount of the fuel pump can be reduced, compared with the case that the fuel pump excessively discharges the fuel by the target discharge quantity and at the target rotational speed for the end of life time of the fuel pump. The electricity for the fuel pump is saved and the fuel economy is improved.

According to another aspect of the present invention, the controller for the fuel pump is provided with a pump evaluation means for evaluating a deterioration degree of the fuel pump. The rotational speed of the fuel pump is corrected in accordance with a deterioration degree and the discharge quantity of the fuel pump is also corrected in accordance with the deterioration degree of the fuel pump. Thereby, the target discharge quantity and the target rotational speed of the fuel pump are defined in accordance with the actual deterioration degree of the fuel pump. Thus, the normal discharge amount of the fuel pump can be reduced, compared with the case that the fuel pump excessively discharges the fuel by the target discharge quantity and at the target rotational speed for the end of life time of the fuel pump. The electricity for the fuel pump is saved and the fuel economy is improved.

According to another aspect of the present invention, the controller is provided with a filter evaluating means for evaluating a pressure loss of the fuel filter and a pump evaluation means for evaluating a deterioration degree of the fuel pump. The target rotational speed of the fuel pump and the target discharge amount of the fuel pump are corrected in accordance with the pressure loss of the fuel filter and the deterioration degree of the fuel pump.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1A is schematic views showing a fuel supply apparatus in a condition in which a fuel amount remaining in a fuel tank is large according to a first to third embodiments;

FIG. 1B is schematic views showing a fuel supply apparatus in condition in which a fuel amount remaining is a fuel tank is small according to a first to third embodiments;

FIG. 2 is a block diagram showing a configuration of a control system;

FIG. 3 is a flowchart showing a target rotational speed computing routine according to the first embodiment;

FIG. 4 is a chart conceptually showing an example of a filter pressure loss correction amount map for computing a filter pressure loss correction amount by use of an integrated value of a discharge quantity as a parameter according to the first embodiment;

FIG. 5 is a chart conceptually showing a two-dimensional map for computing the target rotational speed by use of the target discharge quantity and a fuel as parameters;

FIG. 6 is a flowchart showing a target rotational speed computing routine according to the second embodiment;

FIG. 7 is a chart conceptually showing an example of a pump deterioration correction amount map for computing a pump deterioration correction amount by use of an integrated value of a rotation number as a parameter according to the second embodiment; and

FIG. 8 is a flowchart showing a target rotational speed computing routine according to the second embodiment.

### DETAILED DESCRIPTION OF EMBODIMENTS

Embodiments of the present invention will be described hereinafter.

### First Embodiment

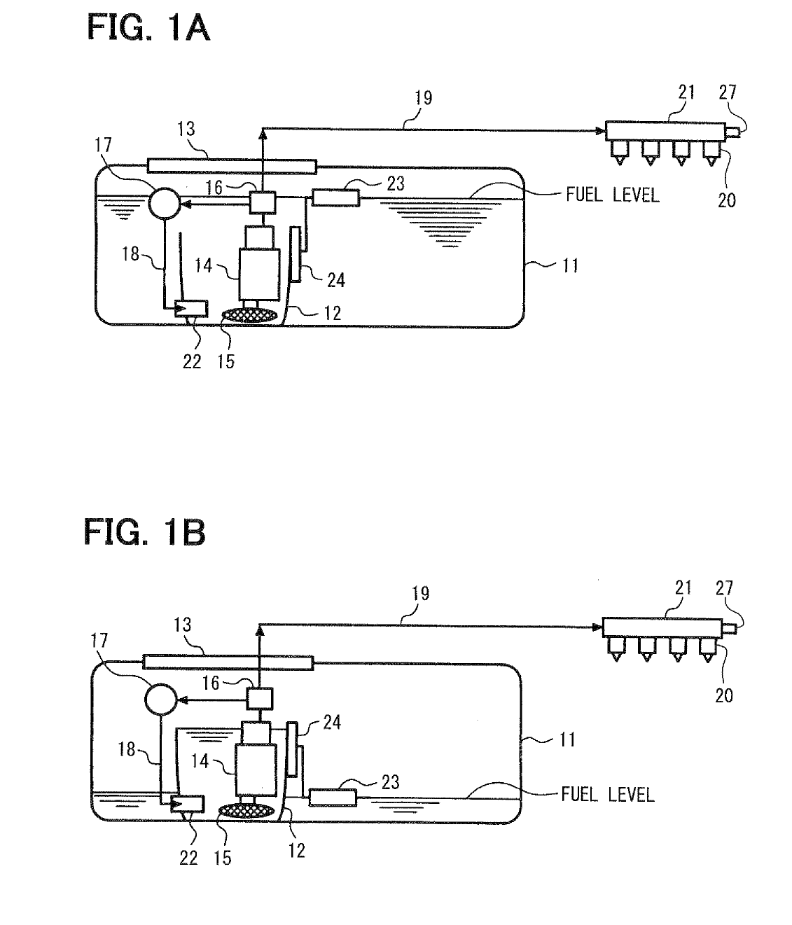

Referring to FIGS. 1A to 5, a first embodiment will be described hereinafter. First, an entire configuration of a fuel supply apparatus pump is schematically explained based on FIGS. 1A and 1B. A fuel tank 11 accommodates a sub-tank 12. As shown in FIG. 1B, when a remaining fuel quantity in the fuel tank 11 is small, a jet pump 22 gathers the fuel into the sub-tank 12. A flange 13 supporting the sub-tank 12 through an elastic member such as a spring is fixed on the fuel tank 11. As shown in FIG. 1A, when a fuel level in the fuel tank 11 is higher than an upper opening of the sub-tank 12, the fuel in the fuel tank 11 is introduced into the sub-tank 12 through the upper opening thereof so that the sub-tank 12 is filled with the fuel.

A fuel pump 14 is provided in the sub-tank 12, A suction filter 15 is provided at an suction port of the fuel pump 14. A fuel filter 16 and a pressure regulator 17 are provided at a discharge port of the fuel pump 14. The fuel filter 16 filtrates the fuel discharged from the fuel pump 14. The pressure regulator 17 adjusts the fuel pressure discharged from the fuel pump 14 in such a manner that the fuel pressure does not exceed a set pressure. A return pipe 18 is connected to the pressure regulator 17 for returning the excessive fuel to the fuel tank 11.

The fuel filtered by the fuel filter 16 is introduced into a delivery pipe 20 through a fuel pipe 19 to distribute the fuel into a fuel injector 21 of each cylinder. The distributed fuel is injected into an intake port of each cylinder from the fuel injector 21 by a fuel injection quantity which is established in accordance with the engine driving condition. The delivery pipe 20 is provided with a fuel pressure sensor 27 detecting a fuel pressure in the delivery pipe 20.

The jet pump 22 is installed at a lower portion of the sub-tank 12 for supplying the fuel in the fuel tank 11 into the sub-tank 12. The return pipe 18 of the pressure regulator 17 is connected to an inlet port of the jet pump 22. The fuel in the return pipe 18 is injected into the inlet port of the jet pump 22, which generate a negative pressure (pumping operation) in the jet pump 22. The fuel in the fuel tank 11 is suctioned into the jet pump 22 by the negative pressure and flows into the sub-tank 12. Thereby, as shown in FIG. 1B, even when a remaining fuel quantity in the fuel tank 11 is small, or even when a fuel level in the fuel tank 11 is tilted, the fuel level in sub-tank 12 is kept higher than the suction port of the fuel pump 14, so that the fuel pump 14 can suction the fuel in the sub-tank 12 stably.

A float 23 floating on the fuel level in the fuel tank 11 and a fuel level gauge 24 measuring a position of the float 23 as the fuel level (remaining fuel quantity) are provided outside of the sub-tank 12.

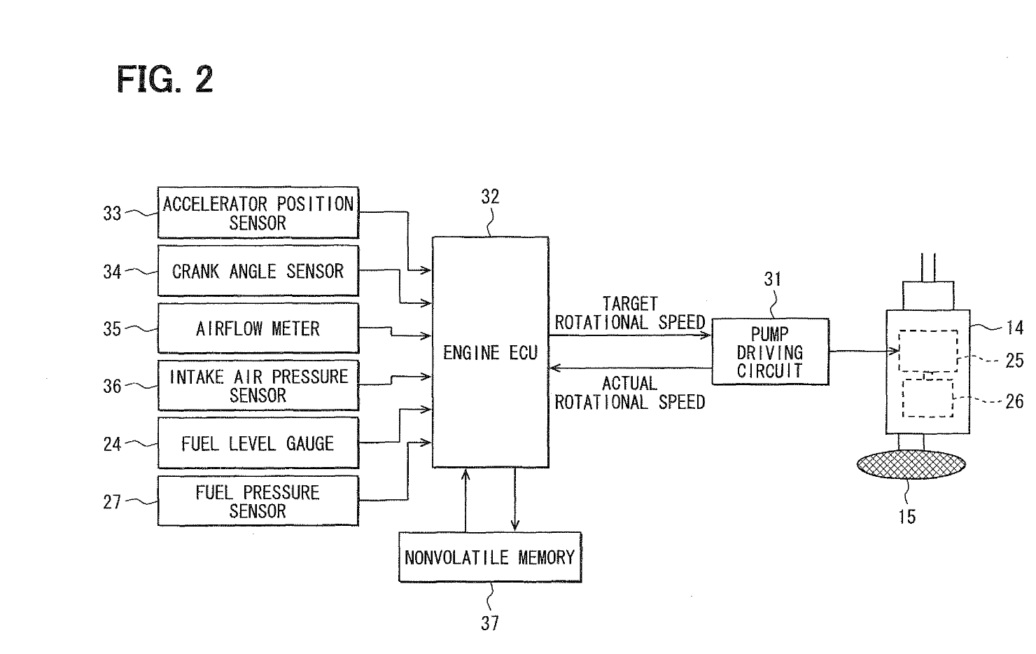

As shown in FIG. 2, the fuel pump 14 has a pump portion 26 driven by a brushless motor 25. The brushless motor 25 is a sensorless type brushless motor. Since the brushless motor 25 of the fuel pump 14 is immersed in the fuel, it is difficult to ensure a credibility of a position detecting sensor, such as a hall element, which detects a rotational position of a rotor. Thus, the sensorless type brushless motor is used. However, if the above problem is solved, a brushless motor having a sensor such as a hall element can be used.

The brushless motor 25 of the fuel pump 14 is driven by a pump driving circuit 31. The pump driving circuit 31 is housed in the fuel pump 14. Alternatively, the pump driving circuit 31 may be provided outside of the fuel pump 14 or the fuel tank 11. The pump driving circuit 31 includes a feedback control circuit (feedback control means) which performs a feedback control so that an actual rotational speed of the fuel pump 14 agrees with the target rotational speed. The pump driving circuit 31 further includes a driving circuit (inverter circuit) which drives the brushless motor 25 based on the output of the feedback control circuit. A rotational speed control of the brushless motor 25 by the pump driving circuit 31 is a well known rotational speed control method, for example, the pulse-width modulation (PWM) method as shown in JP-2000-341982.

The pump driving circuit 31 receives a signal indicative of the target rotational speed of the fuel pump 14, which is transmitted from an engine electronic control unit (engine ECU) 32 controlling the driving of the engine, The pump driving circuit 31 transmits a signal indicative of the actual rotational speed of the fuel pump 14 to the engine ECU 32. According to the present embodiment, the pump driving circuit 31 is configured by a hardware circuit. Alternatively, the function of the feedback control may be realized by software.

The engine ECU 32 receives signals from various sensors, such as an accelerator position sensor 33 detecting an accelerator position, a crank angle sensor 34 detecting an engine speed, an airflow meter 35 detecting an intake air quantity, an intake air pressure sensor 36 detecting an intake air pressure, and the fuel pressure sensor 27. The engine ECU 32 controls a fuel injection quantity of the fuel injector 21 and an ignition timing in accordance with the engine driving condition.

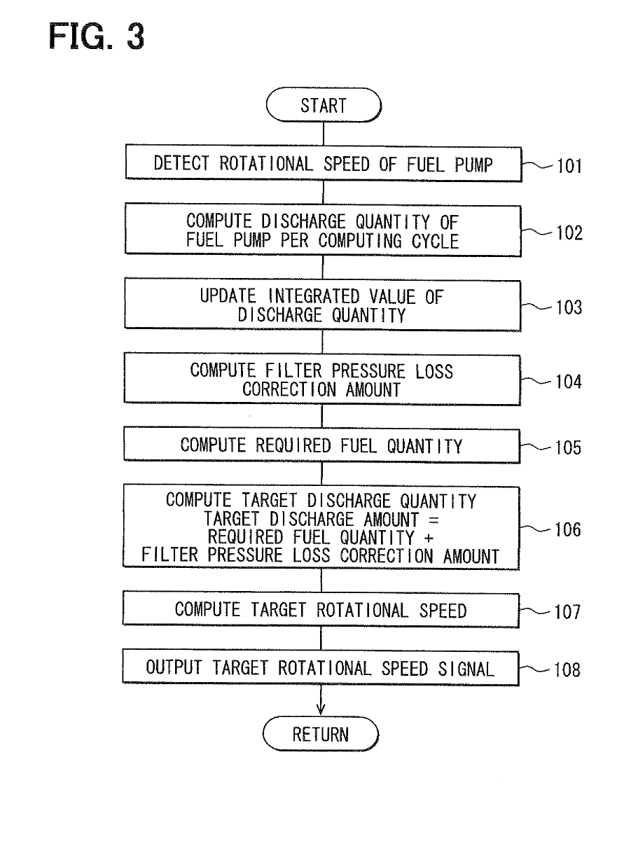

Furthermore, the engine ECU 32 performs a target rotational speed computing routine shown in FIG. 3, whereby the engine ECU 32 functions as a filter pressure loss evaluating means for evaluating a pressure loss of the fuel filter 16. The ECU 32 corrects the rotational speed of the fuel pump 14 in accordance with the evaluated pressure loss to correct the discharge quantity of the fuel pump 14 as well. In order to realize the correction, the engine ECU 32 functions as a target discharge quantity computing means for computing a target discharge quantity by correcting an engine demand fuel quantity with a filter pressure loss correction quantity corresponding to the pressure loss of the fuel filter 16. Further, the engine ECU 32 functions as a target rotational speed computing means for computing a target rotational speed based on the target discharge quantity. The target rotational speed is corrected in accordance with the pressure loss of the fuel filter 16 The engine ECU 32 transmits a signal indicative of the corrected target rotational speed to the pump driving circuit 31. In this pump driving circuit 31, a feedback control is performed in such a manner that the actual rotational speed of the fuel pump 14 agrees with the target rotational speed. The engine ECU 32 and the pump driving circuit 31 configures a control means for correcting the discharge quantity of the fuel pump 14 in accordance with the pressure loss of the fuel filter 16.

In a method for evaluating the pressure loss of the fuel filter 16, an integrated value of the fuel quantity passing through the fuel filter 16 or an integrated value of parameter relating to this fuel quantity can be used as evaluation data for the pressure loss of the fuel filter 16. In a system in which all of the fuel discharged from the fuel pump 14 passes through the fuel filter 16, that is, in a system in which the fuel filter 16 is disposed between the fuel pump 14 and the pressure regulator 17, since the discharge quantity of the fuel pump 14 agrees with the fuel quantity passed through the fuel filter 16, the integrated value of the fuel quantity passed through the fuel filter 16 is calculated by integrating the discharge quantity of the fuel pump 14. Although the discharge quantity of the fuel pump may be computed based on the rotational speed of the fuel pump 14, the target discharge quantity as an information of discharge amount of the fuel pump 14 can reduce a computing load. As a substituting information of the integrated value of the fuel quantity passed through the fuel filter 16, an integrated value of a rotation number of the fuel pump 14 can be used.

In a case that the present invention is applied to a system in which an in-line type fuel filter is disposed between a pressure regulator and a fuel injector, the fuel quantity passed through the fuel filter becomes less than the discharge quantity of the fuel pump by the fuel quantity returned by the pressure regulator. However, since the fuel quantity passed through the fuel filter agrees with the fuel consumption of the engine, the integrated value of the fuel quantity passed through the fuel filter can be calculated by integrating the fuel consumption of the engine (fuel injection quantity).

Since the increase in pressure loss of the fuel filter 16 is a phenomenon which gradually occurs for a long period, an integrated value of refueling quantity measured by a fuel level gauge 24, an integrated travel distance, or an integrated operating time of the engine can be used as the substituting information of the integrated value of the fuel quantity passed through the fuel filter 16. After an average fuel quantity passed through the fuel filter 16 in an average driving condition is obtained, the integrated value of the fuel quantity passed through the fuel filter 16 can be evaluated based on the integrated refueling quantity, the integrated travel distance, or the integrated operating time of the engine.

In this case, the evaluation data of the pressure loss of the fuel filter 16 may be stored in a backup RAM which receives electric power from a battery. Generally, since a lifetime of the fuel filter 16 is longer than that of the battery, the battery is changed to new one before the fuel filter 16 is changed to new one, When the battery is removed to be changed, there is a possibility that the evaluation data of the pressure loss of the fuel filter 16 are erased.

According to the first embodiment, the evaluation data of the pressure loss of the fuel filter is stored in a nonvolatile memory 37, such as EEPROM. Thereby, it is unnecessary to supply electric power to the nonvolatile memory 37 during the engine stop. Even if the battery is changed to new one, the data stored in the nonvolatile memory 37 can be hold. Besides, when the fuel filter 16 is changed to new one, the evaluation data of the pressure loss of the fuel filter 16 stored in the nonvolatile memory 37 are initialized.

Referring to FIG. 3, the target rotational speed computing routine will be described hereinafter. The target rotational speed computing routine is executed by the engine ECU 32 at a specified period during an engine operation. In step 101, the rotational speed of the fuel pump 14 is detected based on a rotational speed signal transmitted from the pump driving circuit 31. Then, the procedure proceeds to step 102 in which a discharge quantity of the fuel pump 14 per a computing cycle is computed based on the rotational speed of the fuel pump 14 by use of a map or a formula. As the rotational speed of the fuel pump 14 becomes higher, the discharge quantity of the fuel pump 14 per a computing cycle is increased, The discharge quantity of the fuel pump 14 per a computing cycle may be computed based on the fuel pressure in addition to the rotational speed.

In step 103, a current discharge amount per a computing quantity is added to a previous integrated value of the discharge quantity stored in the nonvolatile memory 37, so that the integrated value of the discharge amount of the fuel pump 14 from a time of shipping a vehicle until the current computing is updated and stored in the nonvolatile memory 37.

Current integrated value of discharge quantity=Previous integrated value of discharge quantity+Current discharge quantity per computing cycle

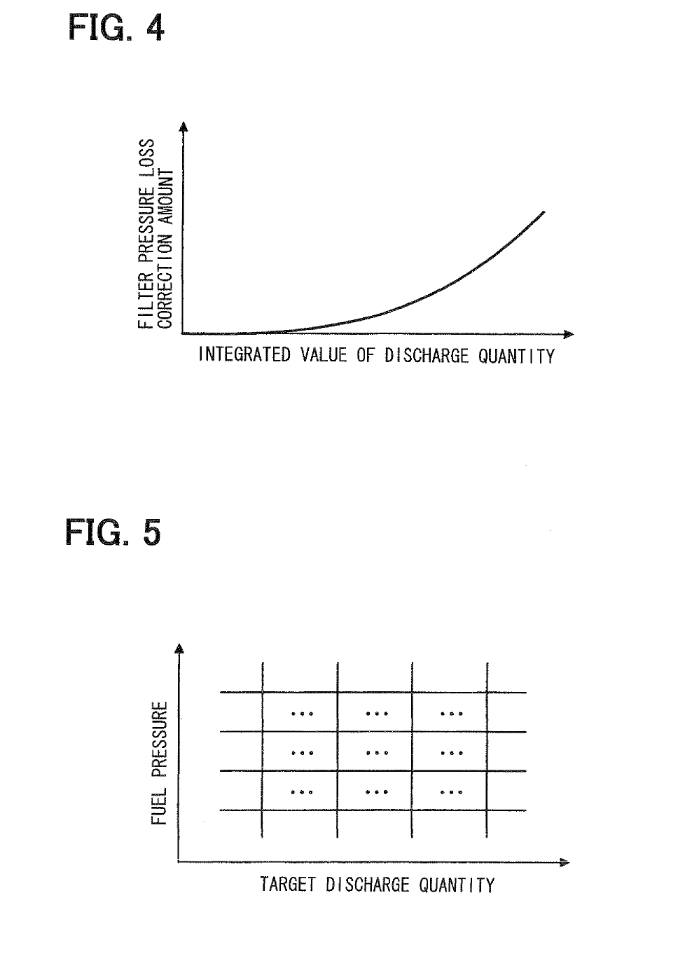

Then, the procedure proceeds to step 104 in which a filter pressure loss correction amount corresponding to the integrated value of discharge quantity is computed based on the integrated value of the discharge amount computed in step 103 as the evaluation data of the pressure loss of the fuel filter 16, referring to a filter pressure loss correction amount map shown in FIG. 4. The filter pressure loss correction amount map is preliminarily formed based on experimental data, design data, simulation results and the like. In this map, as the integrated value of the discharged amount becomes larger, the filter pressure loss correction amount becomes larger, corresponding to an increase in pressure loss of the fuel filter 16.

Then, the procedure proceeds to step 105 in which a fuel quantity required by the engine, which is referred to as a required fuel quantity, is computed according to a following formula.

Required fuel quantity=Injection quantity of fuel injector 21×Engine speed/2×Number of cylinder

In step 106, the filter pressure loss correction amount is added to the required fuel quantity to obtain the target discharge quantity which is corrected in accordance with the pressure loss of the fuel filter 16.

Target discharge quantity=Required fuel quantity+Filter pressure loss correction amount

In step 107, the target rotational speed is computed according to the target discharge quantity and the fuel pressure, referring to two-dimensional map shown in FIG. 5 for computing the target rotational speed of the fuel pump 14. The two-dimensional map is defined by the target discharge quantity and the fuel pressure as parameters. According to the above processing, the target rotational speed is obtained, which is corrected in accordance with the pressure loss of the fuel filter 16.

Then, the procedure proceeds to step 108 in which the engine ECU 32 outputs the target rotational speed signal to the pump driving circuit 31. The pump diving circuit 31 performs a feedback control in such a manner that the actual rotational speed of the fuel pump 14 agrees with the target rotational speed.

According to the above described first embodiment, using the integrated value of the discharge quantity of the fuel pump 14 from a time of new vehicle as the parameter evaluating the pressure loss of the fuel filter 16, the target discharge quantity is obtained by correcting the required fuel quantity with the filter pressure loss correction amount and the target rotational speed of the fuel pump 14 is computed based on the target discharge quantity. The target rotational speed of the fuel pump 14 is corrected in accordance with the pressure loss of the fuel filter 16. The actual rotational speed of the fuel pump 14 is feedback controlled in such a manner as to agree with the target rotational speed. The target discharge quantity and the target rotational speed are defined in accordance with the actual pressure loss of the fuel filter 16. Thus, the normal discharge amount of the fuel pump 14 can be reduced, compared with the case that the fuel pump 14 excessively discharges the fuel by the target discharge quantity and at the target rotational speed for the end of life time of the fuel pump 14. The electricity for the fuel pump 14 is saved and the fuel economy is improved.

Besides, according to the first embodiment, the target rotational speed is computed based on the target discharge amount which is corrected in accordance with the pressure loss of the fuel filter 16. However, the controller may be provided with a target rotational speed computing means for computing the target rotational speed of the fuel pump 14 based on the required fuel quantity or a parameter correlating thereto, a filter pressure loss correcting means for correcting the target rotational speed with the filter pressure loss amount, and a feedback control means for performing a feedback control in such a manner that the actual rotational speed of the fuel pump 14 agrees with the target rotational speed corrected by the filter pressure loss correcting means. In short, the target rotational speed computed based on the required fuel quantity and the like may be corrected in accordance with the pressure loss of the fuel filter 16.

### Second Embodiment

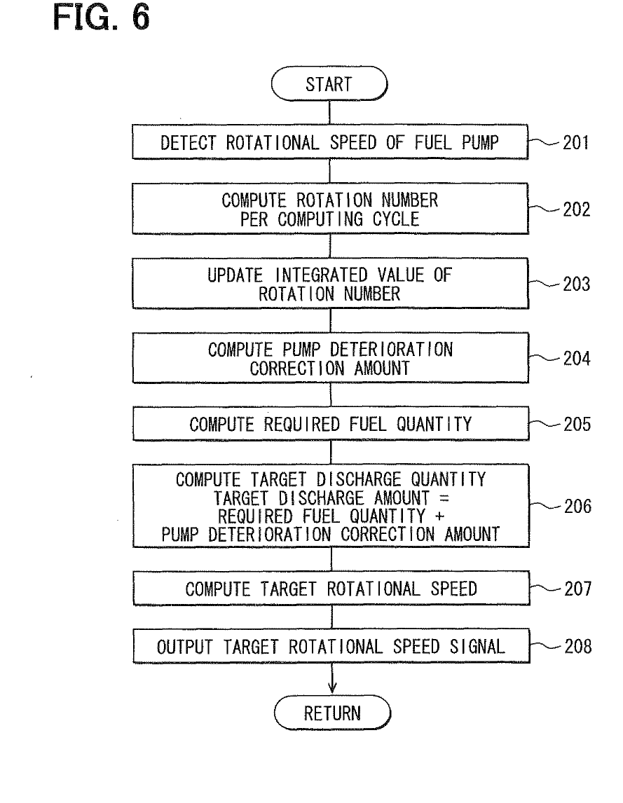

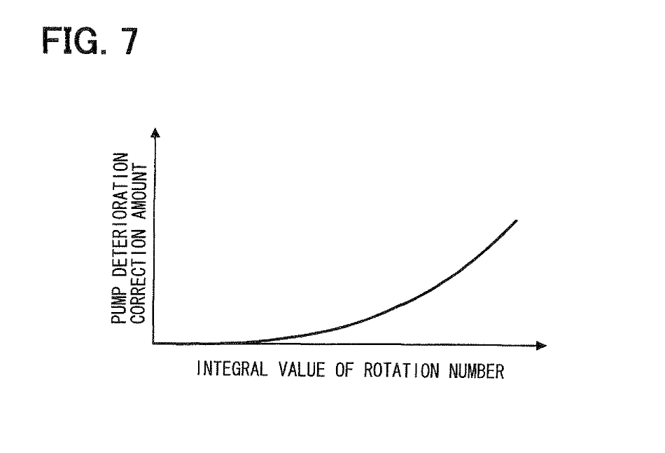

Referring to FIGS. 6 and 7, a second embodiment of the present invention will be described hereinafter. However, an explanation is omitted or simplified about the substantially same portion as the first embodiment, and only the different portion is mainly explained.

According to the second embodiment, the engine ECU 32 executes a target rotational speed computing routine shown in FIG. 6 and functions as a pump deterioration evaluating means for evaluating a deterioration degree of the fuel pump 14, The rotational speed of the fuel pump 14 is corrected in accordance with the deterioration degree of the fuel pump 16 and the discharge quantity of the fuel pump 14 is corrected in accordance with the deterioration degree of the fuel pump 16. In order to realize this correction, the engine ECU 32 functions as a target discharge quantity computing means for computing the target discharge quantity by correcting the required fuel quantity with the pump deterioration correction amount relating to the deterioration degree of the fuel pump 14, a target rotational speed computing means for computing the target rotational speed of the fuel pump 14 based on the target discharge quantity, and a feedback control means for performing a feedback control in such a manner that the actual rotational speed of the fuel pump 14 agrees with the target rotational speed.

In a method evaluating a deterioration degree of the fuel pump 14, an integrated value of a rotation number of the fuel pump 14 or an integrated value of parameter correlating to the rotation number may be used as evaluation data of the deterioration degree of the fuel pump 14. Since the deterioration of the fuel pump 14 gradually occurs for a long period, an integrated operation time, an integrated travel distance, or an integrated refuel quantity may be used as the substitute information of the integrated value of the rotation number. After an average rotation number per a unit operation time of the fuel pump 14 in an average driving condition, an average rotation number per a unit travel distance, or an average rotation number per a unit refuel quantity is previously obtained, the integrated value of the rotation number of the fuel pump 14 can be obtained based on the integrated operation time, the integrated travel distance or the integral refuel quantity.

Also in this case, the evaluation data of the deterioration degree of the fuel pump 14 is stored in the nonvolatile memory 37. Thus, it is unnecessary to supply electricity to the nonvolatile memory 37 from the battery during the engine stop so that the evaluation data are held. Even if the battery is changed to new one, the data stored in the nonvolatile memory 37 can be held. Besides, when the fuel pump 14 is changed to new one, the evaluation data of the deterioration degree stored in the nonvolatile memory 37 may be initialized.

Referring to FIG. 6, the target rotational speed computing routine will be described hereinafter. The target rotational speed computing routine shown in FIG. 6 is executed by the engine ECU 32 at a specified period during an engine operation. In step 201, the rotational speed of the fuel pump 14 is detected based on a rotational speed signal transmitted from the pump driving circuit 31. Then, the procedure proceeds to step 202 in which the rotation number of the fuel pump 14 per a computing cycle is computed based on the rotational speed of the fuel pump 14.

In step 203, a current rotation number per a computing cycle is added to a previous integrated value of the rotation number stored in the nonvolatile memory 37, so that the integrated value of the rotation number of the fuel pump 14 from a time of shipping a vehicle until the current computing is updated and stored in the nonvolatile memory 37.

Current integrated value of rotation number=Previous integrated value of rotation number+Current rotation number per computing cycle

Then, the procedure proceeds to step 204 in which a pump deterioration correction amount corresponding to the integrated value of the rotation number is computed based on the integrated value of the rotation number computed in step 203 as the evaluation data of the deterioration degree of the fuel pump 14, referring to a pump deterioration correction amount map shown in FIG. 7. The pump deterioration correction amount map is preliminarily formed based on experimental data, design data, simulation results and the like. In this map, as the integrated value of the rotation number becomes larger, the pump deterioration correction amount becomes larger.

Then, the procedure proceeds to step 205 in which the required fuel quantity is computed in the same manner as step 105 of the first embodiment. In step 206, the pump deterioration correction amount is added to the required fuel quantity so as to obtain the target discharge amount which is corrected in accordance with the deterioration degree of the fuel pump 14.

Target discharge quantity=Required fuel quantity+Pump deterioration correction amount

Then, the procedure proceeds to step 207 in which the target rotational speed is computed in accordance with the target discharge quantity and the fuel pressure in the same manner as step 107 of the first embodiment. According to the above processing, the target rotational speed is obtained, which is corrected in accordance with the deterioration degree of the fuel pump 14.

Then, the procedure proceeds to step 208 in which the engine ECU 32 outputs the target rotational speed signal to the pump driving circuit 31. The pump diving circuit 31 performs a feedback control in such a manner that the actual rotational speed of the fuel pump 14 agrees with the target rotational speed.

According to the above described second embodiment, using the integrated value of the rotational number of the fuel pump 14 from a time of new vehicle as the parameter evaluating the deterioration degree of the fuel pump 14, the target discharge quantity is obtained by correcting the required fuel quantity with the pump deterioration correction amount. The target rotational speed of the fuel pump 14 is computed based on the target discharge quantity. The target rotational speed of the fuel pump 14 is corrected in accordance with the deterioration degree of the fuel pump 14. The actual rotational speed of the fuel pump 14 is feedback controlled in such a manner as to agree with the target rotational speed. Thus, the normal discharge amount of the fuel pump 14 can be reduced, compared with the case that the fuel pump 14 excessively discharges the fuel by the target discharge quantity and at the target rotational speed for the end of life time of the fuel pump 14. The electricity for the fuel pump 14 is saved and the fuel economy is improved.

Besides, according to the second embodiment, the target rotational speed is computed based on the target discharge amount which is corrected in accordance with the deterioration degree of the fuel pump 14. However, the controller may be provided with a target rotational speed computing means for computing the target rotational speed of the fuel pump 14 based on the required fuel quantity or a parameter correlating thereto, a pump deterioration correcting means for correcting the target rotational speed with the pump deterioration correction amount, and a feedback control means for performing a feedback control in such a manner that the actual rotational speed of the fuel pump 14 agrees with the target rotational speed corrected by the pump deterioration correcting means. in short, the target rotational speed computed based on the required fuel quantity and the like may be corrected in accordance with the deterioration degree of the fuel pump 14.

### Third Embodiment

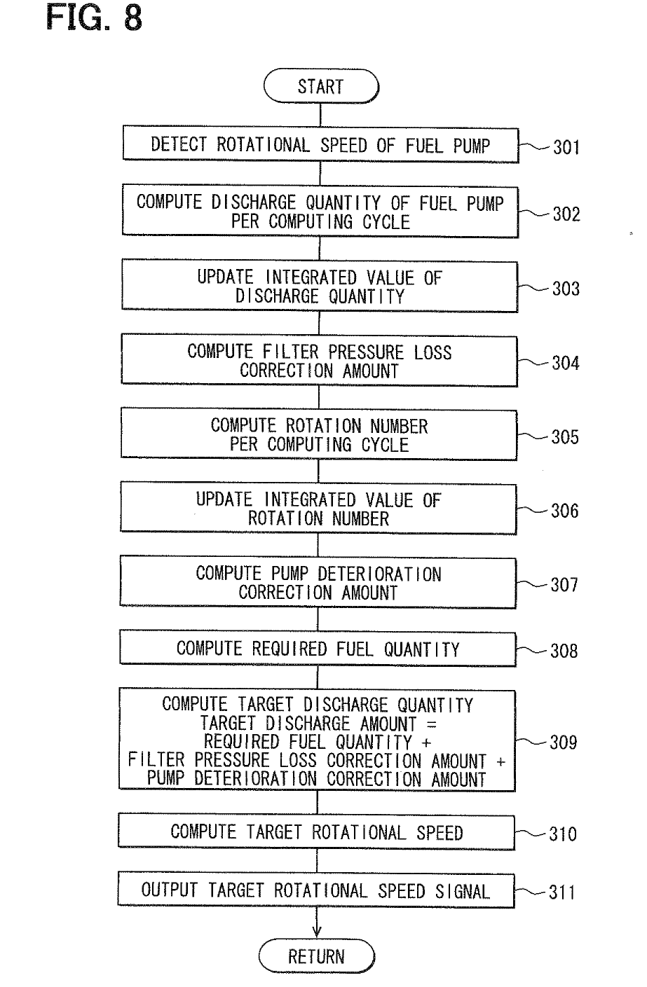

Referring to FIG. 8, a third embodiment of the present invention will be described hereinafter. However, an explanation is omitted or simplified about the substantially same portion as the first and the second embodiment, and only the different portion is mainly explained.

According to the third embodiment, the engine ECU 32 executes a target rotational speed computing routine and functions as a filter pressure loss evaluating means for evaluating the pressure loss of the fuel filter 16 and a pump deterioration degree evaluating means for evaluating the deterioration degree of the fuel pump 14. The rotational speed of the fuel pump 14 is corrected in accordance with the pressure loss of the fuel filter 16 and the deterioration degree of the fuel pump 14, whereby the discharge quantity of the fuel pump 14 is corrected in accordance with the pressure loss of the fuel filter 16 and the deterioration degree of the fuel pump 14.

The target rotational speed computing routine shown in FIG. 8 is executed by the engine ECU 32 at a specified period during an engine operation. In steps 301-304, in the same manner as steps 101-104 of the first embodiment, the discharge quantity of the fuel pump 14 is integrated and the filter pressure loss correction amount is computed in accordance with the integrated value of the discharge quantity.

In step 305-307, in the same manner as steps 202-204 of the second embodiment, the rotational number of the fuel pump 14 is integrated and the pump deterioration correction amount is computed in accordance with the integrated value of the rotation number.

In step 308, the required fuel quantity is computed in the same manner as step 105 of the first embodiment. In step 309, the filter pressure loss correction amount and the pump deterioration correction amount are added to the required fuel quantity whereby the target discharge quantity is obtained, which is corrected based on the pressure loss of the fuel filter 16 and the deterioration degree of the fuel pump 14.

Target discharge quantity=Required fuel quantity+Filter pressure loss correction amount+Pump deterioration correction amount

Then, the procedure proceeds to step 310 in which the target rotational speed is computed in accordance with the target discharge quantity and the fuel pressure. According to the above processing, the target rotational speed is obtained, which is corrected in accordance with the pressure loss of the fuel filter 16 and the deterioration degree of the fuel pump 14.

Then, the procedure proceeds to step 311 in which the engine ECU 32 outputs the target rotational speed signal to the pump driving circuit 31. The pump diving circuit 31 performs a feedback control in such a manner that the actual rotational speed of the fuel pump 14 agrees with the target rotational speed.

According to the third embodiment, since the target rotational speed can be corrected based on both of the pressure loss of the fuel filter 16 and the deterioration degree of the fuel pump 14, both advantages of the first embodiment and the second embodiment can be obtained.

The present invention should not be limited to the above embodiments, but may be implemented in other ways without departing from the spirit of the invention. For example, the engine ECU is provided with a function of a feedback control means, and the pump driving circuit is configured by a simple driving circuit (inverter circuit) without the feedback function.

What is claimed is:

1. A controller for a fuel pump, which pumps up a fuel in a fuel tank by the fuel pump to supply the fuel to an internal combustion engine, filtrating the fuel by a fuel filter, the controller comprising:
a filter evaluating means for evaluating a pressure loss of the fuel filter; and
a control means for controlling a discharge quantity of the fuel pump by controlling a rotational speed of the fuel pump, wherein
the control means corrects the rotational speed of the fuel pump in accordance with the pressure loss of the fuel filter evaluated by the filter evaluating means so as to correct the discharge quantity of the fuel pump in accordance with the pressure loss.

2. A controller for a fuel pump according to claim 1, wherein
the control means includes a target discharge quantity computing means for computing a target discharge quantity by correcting a required fuel quantity of the internal combustion engine with a filter pressure loss correction amount corresponding to the pressure loss of the fuel filter, a target rotational speed computing means for computing a target rotational speed of the fuel pump based on the target discharge quantity, and a feedback control means for performing a feedback control in such a manner that an actual rotational speed of the fuel pump agrees with the target rotational speed.

3. A controller for a fuel pump according to claim 1, wherein
the control means includes a target rotational speed computing means for computing a target rotational speed of the fuel pump, a filter pressure loss correction means for correcting the target rotational speed with a filter pressure loss correction amount corresponding to a pressure loss of the fuel filter, and a feedback control means for performing a feedback control in such a manner that an actual rotational speed of the fuel pump agrees with the target rotational speed.

4. A controller for a fuel pump according to claim 1, wherein
the filter evaluating means uses an integrated value of a fuel passing through the fuel filter or an integrated value of a parameter correlating thereto as an evaluation data of the pressure loss of the fuel filter.

5. A controller for a fuel pump according to claim 1, further comprising a nonvolatile memory storing an evaluation data of the pressure loss of the fuel filter, which is evaluated by the filter evaluating means.

6. A controller for a fuel pump, which pumps up a fuel in a fuel tank by the fuel pump to supply the fuel to an internal combustion engine, the controller comprising:
a pump evaluating means for evaluating a deterioration degree of the fuel pump;
a control means for controlling a discharge quantity of the fuel pump by controlling a rotational speed of the fuel pump, wherein
the control means corrects the rotational speed of the fuel pump in accordance with the deterioration degree of the fuel pump evaluated by the pump evaluating means so as to correct the discharge quantity of the fuel pump in accordance with the deterioration degree of the fuel pump.

7. A controller for a fuel pump according to claim 6, wherein
the control means includes a target discharge quantity computing means for computing a target discharge quantity by correcting a fuel quantity required by the internal combustion engine with a pump deterioration correction amount corresponding to the deterioration degree of the fuel pump, a target rotational speed computing means for computing a target rotational speed of the fuel pump based on the target discharge quantity, and a feedback control means for performing a feedback control in such a manner that an actual rotational speed of the fuel pump agrees with the target rotational speed.

8. A controller for a fuel pump according to claim 6, wherein
the control means includes a target rotational speed computing means for computing a target rotational speed of the fuel pump, a pump deterioration correcting means for correcting the target rotational speed with a pump deterioration correction amount corresponding to a deterioration degree of the fuel pump, and a feedback control means for performing a feedback control in such a manner that an actual rotational speed of the fuel pump agrees with the target rotational speed which is corrected by the pump deterioration correcting means.

9. A controller for a fuel pump according to claim 6, wherein
the pump evaluating means uses an integrated value of a rotation number of the fuel pump or an integrated value of a parameter correlating thereto as an evaluation data of the deterioration degree of the fuel pump.

10. A controller for a fuel pump according to claim 6, further comprising a nonvolatile memory storing an evaluation data of the deterioration degree of the fuel pump, which is evaluated by the pump evaluating means.

11. A controller for a fuel pump, which pumps up a fuel in a fuel tank by the fuel pump to supply the fuel to an internal combustion engine, filtrating the fuel by a fuel filter, the controller comprising:
a filter evaluating means for evaluating a pressure loss of the fuel filter; and
a pump evaluating means for evaluating a deterioration degree of the fuel pump;
a control means for controlling a discharge quantity of the fuel pump by controlling a rotational speed of the fuel pump, wherein
the control means corrects the rotational speed of the fuel pump in accordance with the pressure loss of the fuel filter evaluated by the filter evaluating means and the deterioration degree of the fuel pump evaluated by the pump evaluating means so as to correct the discharge quantity of the fuel pump in accordance with the pressure loss of the fuel filter and the deterioration degree of the fuel pump.
